(19) United States
(12) Patent Application Publication
(10) Pub. No.: US 2016/0373726 A1
(43) Pub. Date: Dec. 22, 2016

(54) METHOD FOR AUTOMATIC OPTICAL-AXIS ALIGNMENT OF CAMERA RIG FOR CAPTURING STEREOGRAPHIC IMAGE

(71) Applicant: REDROVER CO., LTD., Seongnam-si (KR)

(72) Inventors: Jung Il PARK, Seongnam-si (KR); Young Hun KIM, Yongin-si (KR); Dong Soo KIM, Gwangju-si (KR); Jun Woo SEOUNG, Seongnam-si (KR)

(21) Appl. No.: 14/743,744

(22) Filed: Jun. 18, 2015

(51) Int. Cl. H04N 13/02; H04N 13/00; H04N 5/232

(52) U.S. Cl. CPC H04N 13/0246; H04N 13/0239; H04N 5/23296; H04N 13/0007

(57) ABSTRACT

The present invention relates generally to automatic optical-axis alignment of a camera rig, and more particularly to a method for automatic optical-axis alignment of a camera rig on which a right-eye camera and a left-eye camera are installed to capture a stereographic image.

The present invention provides a method for automatic optical axis alignment of a camera rig for capturing a stereographic image in which zoom-in operation and zoom-out operation of a camera are used for short-distance and long-distance optical-axis alignment, whereby both the short-distance optical-axis alignment and the long-distance optical-axis alignment can be automatically conducted without the need either for moving the real target or for a separate optical-axis alignment camera.

### BACKGROUND OF THE INVENTION

1. Field of the Invention

The present invention relates generally to automatic optical-axis alignment of a camera rig, and more particularly to a method for automatic optical-axis alignment of a camera rig on which a right-eye camera and a left-eye camera are installed to capture a stereographic image.

2. Description of the Related Art

Generally, a left-eye image and a right-eye image must be captured in order to obtain a stereographic image. Furthermore, the positions and orientations of the left- and right-eye images must be adjustable so that the distance therebetween, the angle relative to each other, etc. can be adjusted. To achieve the above-mentioned purposes, there is the need for an apparatus on which a left-eye camera for capturing a left-eye image and a right-eye camera for capturing a right-eye image are movably installed. This apparatus is typically called a stereographic camera rig.

FIG. 1 is a view showing a conventional stereographic camera rig. Referring to FIG. 1, a left-eye camera 20 and a right-eye camera 30 are installed in a stereographic camera rig 10 provided with a half mirror 40. The cameras 20 and 30 capture images of a target that pass through or are reflected by the half mirror 60.

When the left-eye image and the right-eye image are displayed on a stereographic display to form a stereographic image, there is a difference in the three-dimensional effect that is felt by the user depending on the degree to which the left- and right-eye images are precisely aligned with correct positions. For this, camera-optical-axis alignment operation of adjusting the cameras must be conducted in order to align the left- and right-eye images with the correct positions.

FIG. 2 is a view showing an optical axis alignment apparatus of the conventional stereographic camera rig.

Referring to FIG. 2, the conventional optical axis alignment apparatus includes a separate optical-axis alignment camera 50 to overcome inconvenience in the camera-optical-axis alignment operation whereby, after camera-optical-axis alignment for a short distance is conducted, camera-optical-axis alignment for a long distance must also be conducted. The separate optical-axis alignment camera 50 makes it possible to simultaneously conduct short-distance optical-axis alignment and long-distance optical-axis alignment.

However, in the conventional technique of FIG. 1, there is a problem of an increase in production costs because a separate optical-axis alignment camera is required for optical axis alignment of the left-eye camera and the right-eye camera. In addition, it is inefficient in that the separate camera is used only for camera-optical-axis alignment.

### PRIOR ART DOCUMENT

### Patent Document

Korean Patent Registration No. 10-1456650

### SUMMARY OF THE INVENTION

Accordingly, the present invention has been made keeping in mind the above problems occurring in the prior art, and an object of the present invention is to provide a method for automatic optical axis alignment of a camera rig for capturing a stereographic image in which zoom-in operation and zoom-out operation of a camera are used for short-distance and long-distance optical-axis alignment, whereby both the short-distance optical-axis alignment and the long-distance optical-axis alignment can be automatically conducted without the need either for moving the real target or for a separate optical-axis alignment camera.

In order to accomplish the above object, the present invention provides a method for automatic optical-axis alignment of a camera rig for capturing a stereographic image. The method includes: a first operation of comparing a reference pattern, stored in a rig control unit and having a center indication pattern on a central portion thereof, with a left-eye image, the left-eye image being obtained by placing a real target, on which a pattern equal to the reference pattern is formed, at a position spaced apart from a left-eye camera by a predetermined distance and then capturing an image of the real target using the left-eye camera, and moving a position of the left-eye camera such that a center indication pattern of the left-eye image is aligned with the center indication pattern of the reference pattern; a second operation of comparing the reference pattern to a right-eye image obtained by capturing an image of the real target using a right-eye camera, and moving a position of the right-eye camera such that a center indication pattern of the right-eye image is aligned with the center indication pattern of the reference pattern; a third operation of zooming in the left-eye camera and the right-eye camera; and a fourth operation of re-conducting the first operation and the second operation in a resultant zoomed-in state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the configuration of a conventional stereographic camera rig;

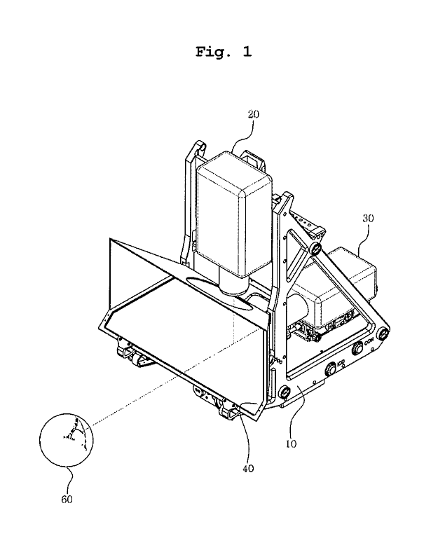

FIG. 2 is a view showing the optical axis alignment apparatus of the conventional stereographic camera rig;

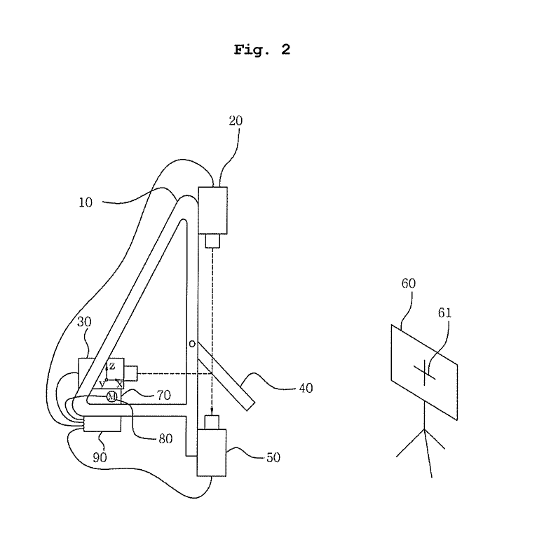

FIGS. 3A and 3B are views showing an example of a reference pattern used in a method for automatic optical-axis alignment of a camera rig according to an embodiment of the present invention;

FIG. 4 is a view showing an example of a real target on which the reference pattern of FIG. 3 is marked;

FIGS. 5A and 5B are views illustrating the process of aligning the optical axis using the real target of FIG. 4;

FIGS. 6A and 6B are views illustrating an example of comparing a pattern of the real target with the reference pattern; and

FIG. 7 is a view illustrating a method for compensating for an error.

### DESCRIPTION OF THE PREFERRED EMBODIMENTS

Hereinafter, exemplary embodiments of the present invention will be described in detail with reference to the attached drawings. However, the present invention is not limited to the exemplary embodiments. The same reference numerals are used throughout the different drawings to designate the same or similar components.

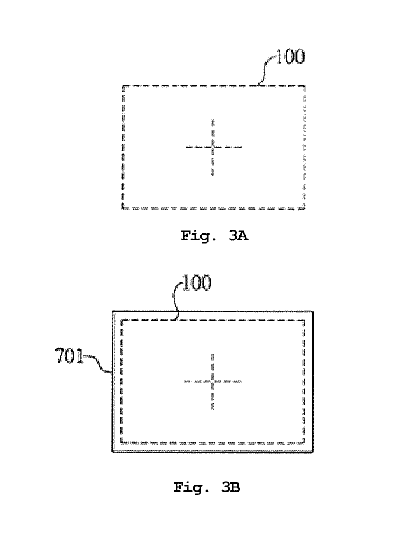

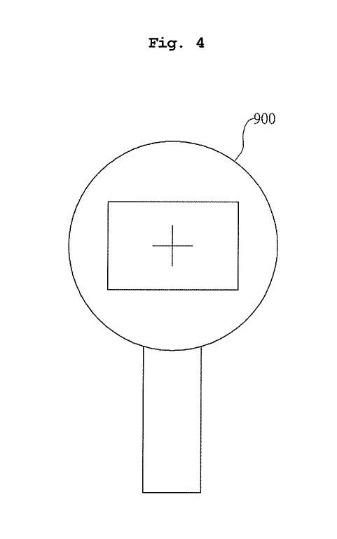

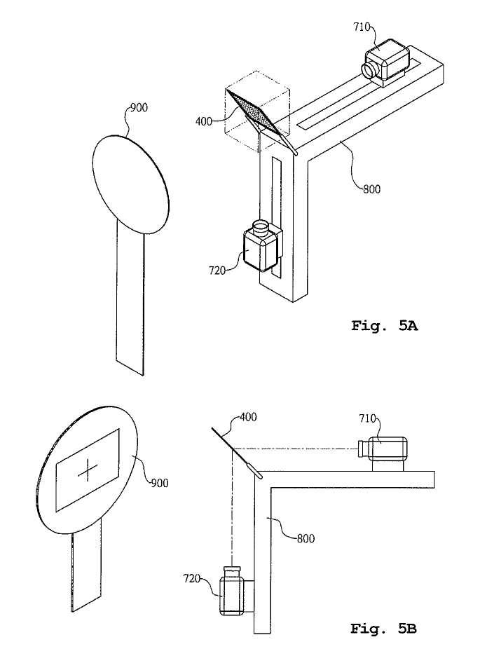

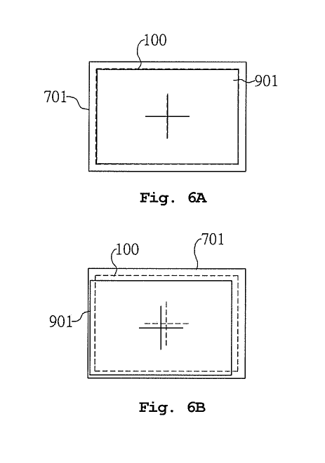

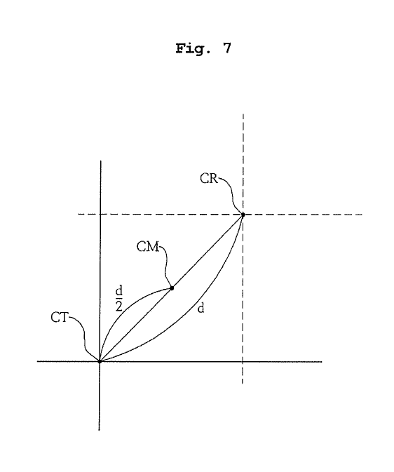

FIGS. 3A and 3B are views showing an example of a reference pattern used in a method for automatic optical-axis alignment of a camera rig according to an embodiment of the present invention. FIG. 4 is a view showing an example of a real target on which the reference pattern of FIGS. 3A and 3B is marked. FIGS. 5A and 5B are views illustrating the process of aligning the optical axis using the real target of FIG. 4. FIGS. 6A and 6B are views illustrating an example of comparing a pattern of the real target with the reference pattern. FIG. 7 is a view illustrating a method for compensating for an error.

FIG. 3A illustrates a reference pattern 100 for alignment of an optical axis of a camera. FIG. 3B shows the reference pattern formed on an image 701 of the camera. As shown in FIG. 3A, the reference pattern 100 includes a center indication pattern on the center thereof, and a rectangular border line.

In this embodiment of the present invention, although the reference pattern has been illustrated as having the structure including the center indication pattern and the rectangular border line, the reference pattern can have a variety of shapes. For instance, patterns of various shapes may be formed not only on the center of the reference pattern but also on the perimeter thereof.

The reference pattern is stored in a rig control unit provided for controlling a camera rig 800 to which a left-eye camera 710 and a right-eye camera 720 are mounted. The rig control unit includes a processor and a memory. The reference pattern is stored in the memory of the rig control unit.

In detail, the reference pattern is stored in the rig control unit before the operation of aligning the optical axis of the camera is conducted.

As shown in FIG. 4, a reference pattern having the same form is also marked on a real target 900 to be image-captured by the camera for the optical axis alignment.

In the method for automatically aligning the optical axis of the camera rig for capturing a stereographic image according to this embodiment of the present invention, the left-eye camera first captures an image of the real target on which the reference pattern is marked.

In detail, after the real target is placed upright at a position spaced apart from the left-eye camera by a predetermined distance, the left-eye camera captures an image of the real target and thus obtains a left-eye image. The photographer using the left-eye camera can see the image of the left-eye image overlapping the reference pattern. The reason for this is because the reference pattern stored in the rig control unit is sent to the left-eye camera and overlapped with the image captured by the left-eye camera.

Referring to FIG. 5, the left-eye camera 710 and the right-eye camera 720 are installed on the camera rig 800. The image of the real target 900 is transmitted through or reflected by a half mirror 400, and is then captured by the left-eye camera 710 and the right-eye camera 720.

Subsequently, the left-eye image is compared with the reference pattern to check whether they match each other.

FIG. 6A shows the case where the reference pattern 100 is precisely aligned with a pattern 901 that is on the left-eye image captured by the left-eye camera. FIG. 6B shows the case where the reference pattern 100 is not precisely aligned with the pattern 901 that is on the left-eye image captured by the left-eye camera.

As shown in FIG. 6B, when the reference pattern is not aligned with the pattern of the left-eye image, the position of the left-eye camera must be moved to align them with each other. In other words, the optical axis alignment of the left-eye camera must be conducted such that the center indication pattern of the reference pattern is aligned with the center indication pattern of the left-eye image.

Thereafter, the right-eye camera must be aligned. In this embodiment, the optical axis alignment for the right-eye camera is conducted in the same manner as that of the above-described optical axis alignment for the left-eye camera. In detail, the reference pattern is compared with a right-eye image obtained by capturing an image of the real target using the right-eye camera. If the reference pattern is not aligned with the pattern of the right-eye image, the position of the right-eye camera is moved such that the center indication pattern of the right-eye image is aligned with the center indication pattern of the reference pattern. For the alignment of the left-eye camera and the right-eye camera, a viewfinder having a vertical and horizontal grid line indicator may be used to enable the user to more reliably check the precision of the alignment.

Thereafter, the left-eye camera 710 and the right-eye camera 720 zoom in.

Even though the center indication patterns of the left- and right-eye images seem to be exactly aligned with the center indication pattern of the reference pattern before the zoom-in operation, it may be found, when the image of the target is viewed more closely by zooming in with the cameras, that the patterns are not exactly aligned with each other.

In this case, the operation of aligning the optical axes of the left- and right-eye cameras must be conducted.

FIG. 7 illustrates in more detail the condition of misalignment of the patterns of FIG. 6B. It can be understood from FIG. 7 that the center indication pattern of the reference pattern is spaced apart from the center indication pattern of the image of the real target by the distance ‘d’.

A method of aligning the optical axis of the left-eye camera includes measuring the distance ‘d’, which is an error distance, and moving the left-eye camera such that the distance ‘d’ is reduced. In detail, the center of the center indication pattern of the image of the real target is moved by ‘d/2’ toward the center of the center indication pattern of the reference pattern. For this, as shown in FIG. 7, the left-eye camera is moved so that the center of the center indication pattern of the captured image is moved to a medial point CM of a line connecting the center CT of the center indication pattern with the center CR of the reference pattern.

A method of aligning the optical axis of the right-eye camera also includes measuring the distance ‘d’, which is an error distance, and moving the right-eye camera such that the distance ‘d’ is reduced. Likewise, the optical axis of the right-eye camera is aligned in such a way that the center of the center indication pattern of the image of the real target is moved by ‘d/2’ toward the center of the center indication pattern of the reference pattern.

Thereafter, the left-eye camera and the right-eye camera zoom out to their original states, that is, their pre-zoomed-in states. In the zoomed-out state, a left-eye image and a right-eye image are obtained again.

Subsequently, whether the center indication pattern of the capture image of the real target is aligned with the center indication pattern of the reference pattern is rechecked.

If the center indication pattern of the capture image of the real target is not aligned with the center indication pattern of the reference pattern, an error distance must be checked to verify whether it exceeds a preset error distance threshold.

As a result of the verification, if the patterns are not aligned with each other but the error distance does not exceed the threshold preset by the user, the operation of aligning the optical axes of the cameras is finished. If the error distance exceeds the threshold, the left-eye camera and the right-eye camera must be realigned so that the error distance can be reduced in the same manner as that of the above-described alignment operation.

The method of realigning the left-eye camera and the right-eye camera is the same as the above-described alignment method. That is, as shown in FIG. 7, ‘d’, which is the error distance, is measured, and each camera is thereafter moved by ‘d/2’ in the direction in which ‘d’ is reduced.

In this way, the operation of re-zooming in the left-eye camera and the right-eye camera, re-aligning the cameras, re-zooming out the cameras, and checking the error distance of each camera to verify whether it exceeds the preset threshold must be repeated.

However, this operation cannot be unlimitedly repeated. Therefore, the user sets in advance a maximum number of operation repetitions. When the number of operation repetitions exceeds the preset maximum number, the user is notified thereof by an alert.

As described above, according to the present invention, both short-distance optical-axis alignment and long-distance optical-axis alignment can be conducted without requiring a separate camera for optical axis alignment.

Furthermore, the zoom-in operation and zoom-out operation of a camera are used for optical-axis alignment. Therefore, the short-distance optical-axis alignment and the long-distance optical-axis alignment can be automatically conducted by the zoom-in operation and the zoom-out operation of the camera without the need to move the real target such that it is disposed at a short distance or a long distance.

Although an exemplary embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for automatic optical-axis alignment of a camera rig for capturing a stereographic image, the method comprising:
a first operation of: comparing a reference pattern, stored in a rig control unit and having a center indication pattern on a central portion thereof, with a left-eye image, the left-eye image being obtained by placing a real target, on which a pattern equal to the reference pattern is formed, at a position spaced apart from a left-eye camera by a predetermined distance and then capturing an image of the real target using the left-eye camera; and moving a position of the left-eye camera such that a center indication pattern of the left-eye image is aligned with the center indication pattern of the reference pattern;
a second operation of: comparing the reference pattern to a right-eye image obtained by capturing an image of the real target using a right-eye camera; and moving a position of the right-eye camera such that a center indication pattern of the right-eye image is aligned with the center indication pattern of the reference pattern;
a third operation of zooming in the left-eye camera and the right-eye camera; and
a fourth operation of re-conducting the first operation and the second operation in a resultant zoomed-in state.

2. The method as set forth in claim 1, further comprising, before the first operation is conducted, storing the reference pattern in the rig control unit, the reference pattern being used for optical axis alignment of the left-eye camera and the right-eye camera.

3. The method as set forth in claim 1, wherein the fourth operation comprises:
a 4-1 operation of measuring, in the zoomed-in state, an error distance between the center indication pattern of the left-eye image and the center indication pattern of the reference pattern, and moving the left-eye camera by ½ of the error distance in a direction in which the error distance is reduced;
a 4-2 operation of measuring, in the zoomed-in state, an error distance between the center indication pattern of the right-eye image and the center indication pattern of the reference pattern, and moving the right-eye camera by ½ of the error distance in a direction in which the error distance is reduced;
a 4-3 operation of zooming out the left-eye camera and the right-eye camera to pre-zoomed-in states; and
a 4-4 operation of re-measuring, in the zoomed-out state, an error distance between the center indication pattern of each of the left- and right-eye images and the center indication pattern of the reference pattern.

4. The method as set forth in claim 3, wherein when the error distance exceeds a preset threshold in the 4-4 operation, each of the left- and right-eye cameras is moved by ½ of the error distance in a direction in which the error distance is reduced so that the center indication pattern of each of the left- and right-eye images is aligned with the center indication pattern of the reference pattern, and then the third operation and the fourth operation are re-conducted.

5. The method as set forth in claim 3, further comprising
a 4-5 operation of notifying a user when the error distance exceeds a preset threshold in the 4-4 operation.

6. The method as set forth in claim 4, wherein the fourth operation is repeated until the error distance is less than the threshold, and
when the error distance still exceeds the threshold after the fourth operation is repeated a preset number of times, information related thereto is provided to a user.
